(19) United States
(12) Patent Application Publication
(10) Pub. No.: US 2015/0346506 A1
(43) Pub. Date: Dec. 3, 2015

(54) OPTICAL LENS AND VIRTUAL IMAGE DISPLAY MODULE

(71) Applicants: Wei-Cheng Huang, Hsin-Chu (TW); Tzu-Hua Huang, Hsin-Chu (TW); Chung-Ting Wei, Hsin-Chu (TW)

(72) Inventors: Wei-Cheng Huang, Hsin-Chu (TW); Tzu-Hua Huang, Hsin-Chu (TW); Chung-Ting Wei, Hsin-Chu (TW)

(73) Assignee: CORETRONIC CORPORATION, Hsin-Chu (TW)

(21) Appl. No.: 14/487,094

(22) Filed: Sep. 16, 2014

(30) Foreign Application Priority Data
May 28, 2014 (TW) 103118658

(51) Int. Cl. G02B 27/42; G02B 27/01; G02B 17/08

(52) U.S. Cl. CPC G02B 27/4205; G02B 17/08; G02B 27/0172; G02B 27/0149; G02B 2027/0152; G02B 2027/0161; G02B 2027/0154

(57) ABSTRACT

An optical lens, adapted for transmitting an image light beam generated by an image display unit to at least one eye of a user. The optical lens includes a reflecting unit, an L-type lens and a diffractive optical element. The reflecting unit, the L-type lens and the diffractive optical element are disposed on a transmission path of the image light beam. The L-type lens has a first portion and a second lens portion integrally molded with each other. The first lens portion is disposed between the image display unit and the reflecting unit. The second lens portion is disposed between the reflecting unit and the eye. The image light beam is transmitted to the eye through the first lens portion, the reflecting unit, the second lens portion and the diffractive optical element to provide a virtual image. Besides, a virtual image display module is also provided.

### CROSS-REFERENCE TO RELATED APPLICATION

This application claims the priority benefit of Taiwan application serial no. 103118658, filed on May 28, 2014. The entirety of the above-mentioned patent application is hereby incorporated by reference herein and made a part of this specification.

### BACKGROUND

1. Field of the Invention

The invention is directed to an optical module and a display module and more particularly, to an optical lens and a virtual image display module.

2. Description of Related Art

Along with development of display technology and people's desire for high technology, techniques of virtual reality and augmented reality gradually become mature, and head mounted displays (HMDs) are displays for implementing the above techniques. The developing history of the HMDs can be traced back to U.S. military in the 1970s, which utilizes an optical projecting system to project images or text messages of a display device to users' eyes. In recent years, as resolution of micro-displays becomes higher and dimensions and power consumption of the micro-displays become lower, the HMDs had also been developed into a portable display device. In addition to the military field, the display technology of the HMDs also have grown and played an important role in other fields such as industrial fabrication, simulation training, three-dimensional display, medical, sports, navigation, and video games.

In general, HMDs usually utilizes Near Eye Display (NED) system to generate images. Since the NED system is only few centimeters away from human eyes, and an HMD has to be worn on a user's head, how to install a light, thin, compact-sized optical system in the HMD had become an important consideration for the design. Meanwhile, in order to achieve high resolution and high color performances, an optical system usually relies on increasing the number of lenses to eliminate aberration and to improve the image quality. In this way, the volume and weight of the HMD easily lead to discomfort of the user. Moreover, the increase of the number of the optical elements also results in difficulty of mechanism positioning. Therefore, how to retain the image quality of the HMDs while fulfilling the demands for compacted volumes and reduce the difficulty of making the system has become one of the important subjects in the related technology field.

U.S. Pat. No. 6,011,653, U.S. Pat. No. 7,884,985 and U.S. Pat. No. 8,184,350 all disclose a head mounted display, and U.S. Pat. No. 7,630,142 discloses a bent type zoom lens.

### SUMMARY

The invention provides an optical lens and a virtual image display module having advantages, such as being small-sizes, having good imaging quality and high manufacturing yield.

Other features and advantages of the invention can be further understood by the technical features disclosed in the invention.

To achieve one, part, or all of the objectives aforementioned or other objectives, an embodiment of the invention provides an optical lens adapted for transmitting an image light beam generated by an image display unit to at least one eye of a user. The optical lens includes a reflecting unit, an L-type lens and a diffractive optical element. The reflecting unit is disposed on a transmission path of the image light beam. The L-type lens is disposed on the transmission path of the image light beam and has a first lens portion and a second lens portion, the second lens portion is integrally molded with the first lens portion. The first lens portion is disposed between the image display unit and the reflecting unit. The second lens portion is disposed between the reflecting unit and the eye. The diffractive optical element is disposed on the transmission path of the image light beam. The image light beam is transmitted to the eye through the first lens portion, the reflecting unit, the second lens portion and the diffractive optical element to provide a virtual image.

To achieve one, part, or all of the objectives aforementioned or other objectives, an embodiment of the invention provides a virtual image display module disposed in front of at least one eye of a user. The virtual image display module includes an image display unit and an optical lens as described above. The image display unit provides an image light beam.

In an embodiment of the invention, the first lens portion has a first optical axis, the second lens portion has a second optical axis, and a first included angle is between the first optical axis and the second optical axis, where the first included angle ranges about from 70 to 110 degrees.

In an embodiment of the invention, the L-type lens has at least one sidewall, and the at least one sidewall is connected with the first lens portion and the second lens portion.

In an embodiment of the invention, the L-type lens further has at least one positioning portion configured to install the reflecting unit.

In an embodiment of the invention, an amount of the at least one positioning portion is plural, and the positioning portions are configured to install the reflecting unit and the diffractive optical element.

In an embodiment of the invention, a second included angle is between the first optical axis and the second optical axis, where the included ranges about from 70 to 110 degrees.

In an embodiment of the invention, the diffractive optical element is disposed between the image display unit and the first lens portion.

In an embodiment of the invention, the diffractive optical element is disposed inside the L-type lens and adjacent to the first lens portion.

In an embodiment of the invention, the diffractive optical element is disposed inside the L-type lens and adjacent to the second lens portion.

In an embodiment of the invention, the diffractive optical element is disposed between the second lens portion and the eye.

In an embodiment of the invention, the optical lens moves relatively to the image display unit to adjust an imaging position and an imaging frame size of the virtual image.

Based on the above, the embodiments of the invention achieve at least one of the following advantages or effects. The virtual image display module and the optical lens can be prevented from an issue that positioning cannot be easily and precisely controlled during the assembly of a plurality of optical elements by means of the integrally molded structure of the L-type lens, such that difficulty of system assembling can be reduced to further lower down system manufacturing cost. Moreover, the virtual image display module and the optical lens can achieve good imaging quality with the disposition of the diffractive optical element as well as achieve a structure having a light weight and a small volume.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a virtual image display module according to an embodiment of the invention.

FIGS. 2A through 2D are schematic views showing different types of the L-type lens depicted in FIG. 1.

FIG. 3 is a schematic view of a virtual image display module according to another embodiment of the invention.

FIG. 4 is a schematic view of a virtual image display module according to yet another embodiment of the invention.

FIG. 5 is a schematic view of a virtual image display module according to still another embodiment of the invention.

### DESCRIPTION OF EMBODIMENTS

Both the foregoing and other technical descriptions, features and advantages of the invention are intended to be described more comprehensively by providing an embodiment accompanied with drawings hereinafter. The language used to describe the directions such as up, down, left, right, front, back or the like in the reference drawings is regarded in an illustrative rather than in a restrictive sense. Thus, the language used to describe the directions is not intended to limit the scope of the invention.

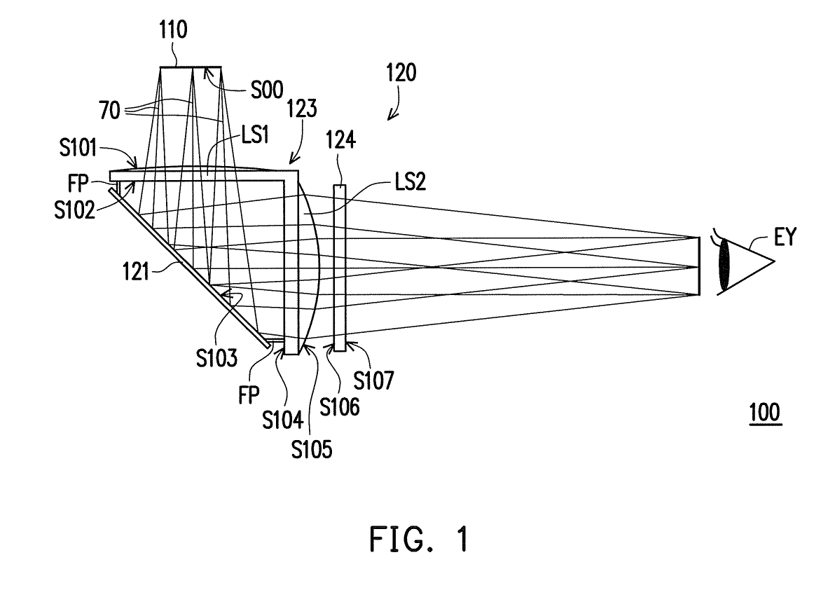

FIG. 1 is a schematic view of a virtual image display module according to an embodiment of the invention. With reference to FIG. 1, in the embodiment, a virtual image display module 100 is disposed in front of at least one eye EY of a user. The virtual image display module 100 includes an image display unit 110 and an optical lens 120. The image display unit 110 provides an image light beam 70. For example, in the embodiment, the image display unit 110 may be a micro liquid crystal display (LCD) panel, a liquid crystal on silicon (LCOS) micro display and a digital micromirror device (DMD) or any other type of micro display, which is not limited in the invention.

On the other hand, in the embodiment, the optical lens 120 includes a reflecting unit 121, an L-type lens 123 and a diffractive optical element 124. For example, the reflecting unit 121 is a reflecting mirror or plated with a reflective metal film which cause an optical transmission path of the image light beam 70 to be deflected, but the invention is not limited thereto. In another embodiment, the reflecting unit 121 may also be a beam splitting element capable of partially penetrating and partially reflecting incident light to deflect part of the image light beam 70 which is transmitted to the eye EY while an image light beam from the external environment passing through the reflecting unit 121 can be transmitted to the eye EY, such that the virtual image display module 100 can also have a see-through function. Additionally, in the embodiment, the L-type lens 123 is made of, for example, optical plastic, so as to reduce the weight of the optical lens 120 and the virtual image display module 100.

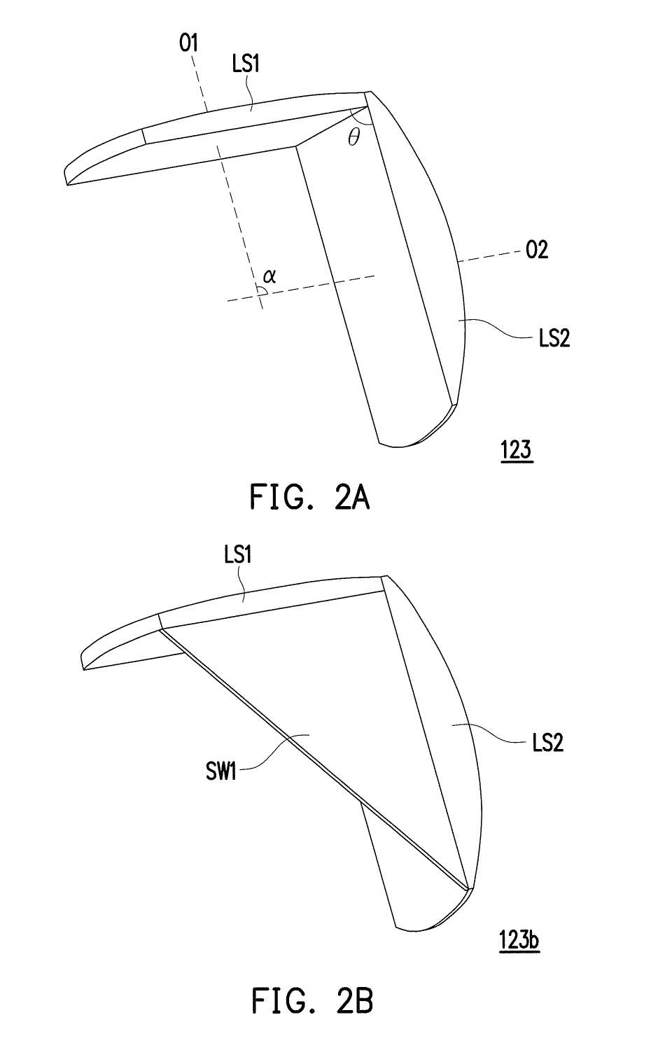

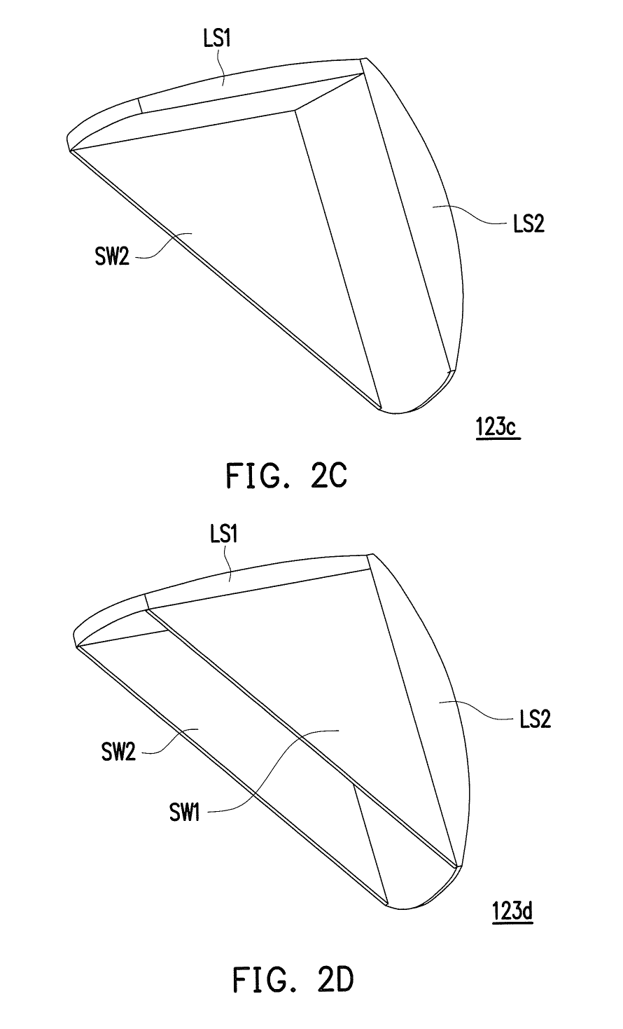

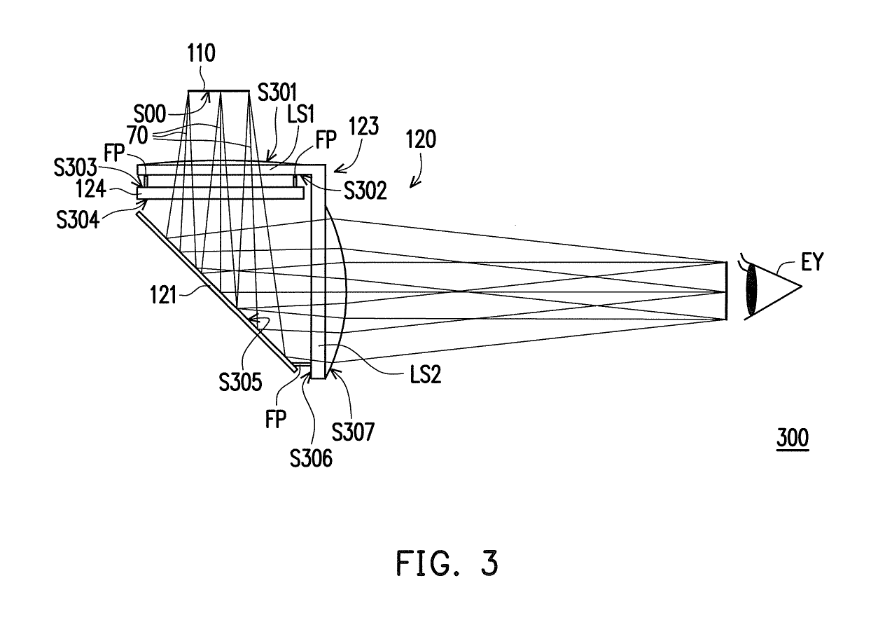

FIG. 2A illustrates a type of the L-type lens depicted in FIG. 1. Referring to FIG. 2A, In particular, the L-type lens 123 has a first lens portion LS1 and a second lens portion LS2 which is integrally molded with the first lens portion LS1. To be detailed, in the embodiment, the first lens portion LS1 and the second lens portion LS2 of the L-type lens 123 are integrally molded with each other by means of injection molding during a fabrication process, such that simplicity of mold manufacturing and yield of product injection molding can be significantly improved to achieve production cost down. Additionally, since the first lens portion LS1 and the second lens portion LS2 of the L-type lens 123 are integrally molded component, the issue that the positioning is not easy to control when a plurality of optical elements are assembled can be avoided to reduce the difficulty of system assembling and the system manufacturing cost.

To be more detailed, in the present embodiment, an included angle θ is between the first lens portion LS1 and the second lens portion LS2, and the included angle θ ranges about from 70 to 110 degrees. The first lens portion LS1 has a first optical axis O1, the second lens portion LS2 has a second optical axis O2, and an included angle α is between the first optical axis O1 and the second optical axis O2, and the included angle α ranges about from 70 to 110 degrees. For example, in the embodiment, the included angle θ between the first lens portion LS1 and the second lens portion LS2 is 90 degrees, and the first optical axis O1 is substantially orthogonal to the second optical axis O2. It should be noted that, the range of each parameter is used only for illustration, and is not intended to limit the invention.

Additionally, although the L-type lens 123 is formed by the first lens portion LS1 and the second lens portion LS2 for example, but the invention is not limited thereto. In other embodiments, the L-type lens may further have at least one sidewall, and possible modifications of the L-type lens 123 will further be described with reference to FIGS. 2B through 2D.

FIGS. 2B through 2D are schematic views showing different types of the L-type lens depicted in FIG. 1. Referring to FIGS. 2B to 2D, L-type lenses 123b, 123c and 123d are similar to the L-type lens 123 in FIG. 1, and the difference between the L-type lenses 123b, 123c and 123d and the L-type lens 123 will be described as below. Referring to FIGS. 2B to 2C, in the embodiment, a sidewall SW1 (illustrated in FIG. 2B) or SW2 (illustrated in FIG. 2C) is disposed on one side of the L-type lens 123b or 123c, and the sidewall SW1 of the L-type lens 123b or the sidewall SW2 of the L-type lens 123c is connected with the first lens portion LS1 and the second lens portion LS2. On the other hand, referring to FIG. 2D, two sidewalls SW1 and SW2 are disposed on two sides of the L-type lens 123d, and the sidewalls SW1 and SW2 are connected with the first lens portion LS1 and the second lens portion LS2. By doing so, structure strength of the L-type lenses 123b, 123c and 123d can be enhanced, and the positioning of the first lens portion LS1 and the second lens portion LS2 can be precisely controlled to lower down the risk of misalignment.

Referring to FIG. 1 again, in the embodiment, the L-type lens 123 further has at least one positioning portion FP configured to install the reflecting unit 121. For example, in the embodiment, the positioning portion FP is a positioning post fixed onto the reflecting unit 121 to position the reflecting unit 121 on the L-type lens 123, which is not limited in the invention. In other embodiments, the positioning portion FP may also be a positioning slot to achieve the installation of the reflecting unit 121. In this way, the optical lens 120 does not need to be equipped with any additional member to install the reflecting unit 121, such that the weight of the optical lens 120 can be reduced.

To be more detailed, both diopters of the first lens portion LS1 and the second lens portion LS2 are positive. Additionally, in the embodiment, at least one surface of the first lens portion LS1 is aspheric, and at least one surface of the second lens portion LS2 is aspheric. For example, a surface S101 of the first lens portion LS1 and a surface S105 of the second lens portion LS2 are aspheric. Additionally, in the embodiment, a surface S102 of the first lens portion LS1 and a surface S104 of the second lens portion LS2 may be selectively manufactured as planes to improve the injection molding yield and to reduce manufacturing cost. In this way, with the design which at least one surface of the first lens portion LS1 and at least one surface of the second lens portion LS2 are aspheric, aberration between the optical lens 120 and the virtual image display module 100 can be mitigated.

On the other hand, color lights having different wave lengths cannot be focused on the same plane of a conventional lens, and would result in chromatic aberration. To fix the chromatic aberration issue, in the embodiment, the diffractive optical element 124 may adopts an optical element capable of producing a diffraction effect for the image light beam 70, such as a diffractive grating, a holographic optical element, a binary optical element or a diffractive fresnel lens, to eliminate the chromatic aberration. Thus, the optical lens 120 can have a good chromatic aberration correction effect to have good imaging quality and a light-weighted and small-volumed structure.

Continuously referring to FIG. 1, specifically, in the embodiment, the reflecting unit 121, the first lens portion LS1, the second lens portion LS2 and the diffractive optical element 124 are disposed on the transmission path of the image light beam 70. The first lens portion LS1 is disposed between the image display unit 110 and the reflecting unit 121. The second lens portion LS2 is disposed between the reflecting unit 121 and the eye EY of the user. The diffractive optical element 124 is disposed between the second lens portion LS2 and the eye EY of the user. Furthermore, after the image light beam 70 emits from the image display unit 110, the image light beam 70 is transmitted to the reflecting unit 121 through the first lens portion LS1 and the transmission path of the image light beam 70 is deflected by the reflecting unit 121, so as to shorten an axial distance of the optical lens 120, which leads the optical lens 120 and the virtual image display module 100 to having thin structural designs. For example, in the embodiment, a deflecting angle of the transmission path of the image light beam 70 is about 90 degrees, but the invention is not limited thereto. In other embodiments, the deflecting angle of the transmission path of the image light beam 70 may ranges about from 70 to 110 degrees. Then, the image light beam 70 reflected by the reflecting unit 121 may be transmitted to the eye EY of the user through the second lens portion LS2 and the diffractive optical element 124 to provide a virtual image. It should be noted that, the range of each parameter is used only for illustration, and is not intended to limit the invention.

Furthermore, in the embodiment, the user may adjust a relative distance between the optical lens 120 and the image display unit 110 by using a control unit (not shown) to adjust an imaging position and an imaging frame size of the virtual image, which facilitates in improving convenience in using the virtual image display module 100. On the other hand, for a user with myopia or hyperopia, a virtual image display apparatus may also get adapted to a diopter of the eye EY for each different user while the relative distance between the optical lens 120 and the image display unit 110 are adjusted. Thus, in the embodiment, the user with myopia or hyperopia can clearly observe a frame displayed by the virtual image display apparatus without wearing correction spectacles.

Accordingly, the virtual image display module 100 and the optical lens 120 can be prevented from the issue that the positioning cannot be easily and precisely controlled during the assembly of a plurality of optical elements by means of the integrally molded structure of the L-type lens 123, such that difficulty of system assembling can be reduced to further lower down system manufacturing cost. Moreover, the virtual image display module 100 and the optical lens 120 can achieve good imaging quality with the disposition of the diffractive optical element 124 as well as achieve a structure having a light weight and a small volume. On the other hand, the virtual image display module 100 and the optical lens 120 can adjust an imaging position and an imaging frame size of the virtual image by means of adjusting the relative distance between the optical lens 120 and the image display unit 110 which facilitates in improving the convenience in using the virtual image display module 100. Meanwhile, the user with myopia or hyperopia can clearly observe the frame displayed by the virtual image display apparatus without additionally wearing correction spectacles.

An embodiment of the virtual image display module 100 is provided hereinafter. However, the invention is not limited to the data listed below. It should be known to those ordinary skilled in the art that various modifications and variations can be made to the structure of the invention without departing from the scope or spirit of the invention.

TABLE 1

| | Surface | Curvature | Interval | |
|---|---|---|---|---|
| Surface | Type | Radius (mm) | (mm) | Note |
| S00 | Spheric | ∞ | 5.4 | Image display unit |
| | | | | 110 |
| S101 | Aspheric | 19.1 | 1.0 | First lens portion |
| | | | | LS1 |
| S102 | Spheric | ∞ | 6.2 | |
| S103 | Spheric | ∞ | 6.2 | Reflecting unit121 |
| S104 | Spheric | ∞ | 2.5 | Second lens |
| | | | | portion LS2 |
| S105 | Aspheric | −12.6 | 0.5 | |
| S106 | Spheric | ∞ | 0.7 | Diffractive optical |
| | | | | element 124 |
| S107 | Spheric | ∞ | 25 | |

In Table 1, a curvature radius refers to a curvature radius of each surface, and an interval refers to a distance between two adjacent surfaces. For instance, an interval of the surface S101 refers to a distance from the surface S101 to the surface S102 on the optical axis. A thickness corresponding to each lens in the note column refers to a value corresponding to each interval on the same row. Additionally, a surface S00 is a display surface of the image display unit 110, the surface S101 is a surface of the first lens portion LS1 facing toward the image display unit 110, the surface S102 is a surface of the first lens portion LS1 facing toward the reflecting unit 121, a surface S103 is a reflecting surface of the reflecting unit 121, surfaces S104 and S105 are two surfaces of the second lens portion LS2, and surfaces S106 and S107 are two surfaces of the diffractive optical element 124.

Based on the above, the surfaces S101 and S105 are aspheric, of which an aspheric formula is as follows.

$$z = \frac{{cr}^{2}}{1 + \sqrt{1 - ( 1 + k ) {c}^{2} {r}^{2 }}} + {α}_{1} {r}^{2} + {α}_{2} {r}^{4} + {α}_{3} {r}^{6}$$

Therein, z is an offset of the optical axis, c is a curvature of an osculating sphere which is approximate to a reciprocal (e.g., a curvature radius of S101 or a curvature radius of S105 in the table) of a curvature radius close to the optical axis, k is a conic constant, r is an aspheric height, i.e., a height from a lens center to a lens edge, where different values of r correspond to different values of z according to the formula, α1, α2 and α3 are aspheric coefficients, and the surfaces S101 and S105 have aspheric coefficients and k values as listed in Table 2.

TABLE 2

| Surface | k | α₁ | α₂ | α₃ |
|---|---|---|---|---|
| S101 | −12.6 | 0 | −6.70E−05 | 0 |
| S105 | −2 | 0 | −7.30E−05 | 0 |

Based on the above, a surface S106 is a diffraction surface, of which a formula thereof is as follows.

$$Φ = M {\sum }_{i = 1}^{N} {A}_{i} {ρ}^{2 i}$$

Therein, Φ is a phase profile function, ρ is a height of a regularized radial aperture, Ai is an even power order coefficient of a height (i.e., ρ) of a normalized radial aperture, and M is a diffraction order. According to the formula, different values of ρ correspond to different values of Φ according to the formula. The coefficient Ai for each order of ρ values of the surface S106 is shown in Table 3.

TABLE 3

| Surface | A2 | A4 | A6 |
|---|---|---|---|
| S106 | −700 | 35 | −7.6 |

Moreover, although in the optical lens 120, the diffractive optical element 124 is disposed between the second lens portion LS2 and the eye EY of the user, the invention is not limited thereto. In other embodiments, the diffractive optical element 124 may also be disposed on another location, which will be further described with reference to FIGS. 3 through 5 below.

FIG. 3 is a schematic view of a virtual image display module according to yet another embodiment of the invention. With reference to FIG. 3, a virtual image display module 300 of the embodiment is similar to the virtual image display module 100 in FIG. 1, and the difference therebetween is described as below. In the virtual image display module 300 of the embodiment, the diffractive optical element 124 may be disposed inside the L-type lens 123 and adjacent to the first lens portion LS1. Meanwhile, in the embodiment, the L-type lens 123 has a plurality of positioning portions FP, and the positioning portions FP are configured to install the reflecting unit 121 and the diffractive optical element 124, so as to achieve the reduction of the system weight without disposing additional mechanical members.

In the embodiment, the operation of the virtual image display module 300 is similar to that of the virtual image display module 100. Thus, details related thereto can refer to the above description and will be not repeatedly described. Since the virtual image display module 300 and the virtual image display module 100 have similar structures, the issue that the positioning cannot be easily and precisely controlled during the assembly of a plurality of optical elements can be prevented by means of the integrally molded structure of the L-type lens 123, such that the difficulty of system assembling can be reduced. Therefore, the virtual image display module 300 have the same advantages as the virtual image display module 100, which will not be repeatedly described hereinafter.

An embodiment of the virtual image display module 300 is provided hereinafter. However, the invention is not limited to the data listed below. It should be known to those ordinary skilled in the art that various modifications and variations can be made to the structure of the invention without departing from the scope or spirit of the invention.

TABLE 4

| | | Curvature | Interval | |
|---|---|---|---|---|
| Surface | Surface Type | Radius(mm) | (mm) | Note |
| S00 | Spheric | ∞ | 5.6 | Image display unit 110 |
| S301 | Aspheric | 24 | 1.4 | First lens portion LS1 |
| S302 | Spheric | ∞ | 0.5 | |
| S303 | Spheric | ∞ | 0.7 | Diffractive optical |
| | | | | element 124 |
| S304 | Spheric | ∞ | 6 | |
| S305 | Spheric | ∞ | 6 | Reflecting unit121 |
| S306 | Spheric | ∞ | 2.5 | Second lens portion LS2 |
| S307 | Aspheric | −11.7 | 25 | |

In Table 4, curvature radiuses and intervals have the same meanings as Table 1, which can refer to Table 1 and will not be repeatedly described below. A surface S301 is a surface of the first lens portion LS1 facing toward the image display unit 110, a surface S302 is a surface of the first lens portion LS1 facing toward the reflecting unit 124, surfaces S303 and S304 are two surfaces of the diffractive optical element 124, a surface S305 is a reflecting surface of the reflecting unit 121, and surfaces S306 and S307 are two surfaces of the second lens portion LS2.

Based on the above, the surfaces S301 and S307 are aspheric, and the surface S304 is a diffraction surface, of which a formula thereof is the same as the formula applied in Table 1, where the physical meaning of each parameter can refer to the description with respect to Table 1 and will not be repeated below. Aspheric coefficients and each parameter value of the surfaces S301 and S307 and each parameter value of the diffractive surface S304 are listed in Table 5 and Table 6.

TABLE 5

| Surface | K | α₁ | α₂ | α₃ |
|---|---|---|---|---|
| S301 | 19 | 0 | −6.80E−04 | 0 |
| S307 | −1.6 | 0 | −7.30E−05 | 0 |

TABLE 6

| Surface | A2 | A4 | A6 |
|---|---|---|---|
| S304 | −1800 | −100 | 600 |

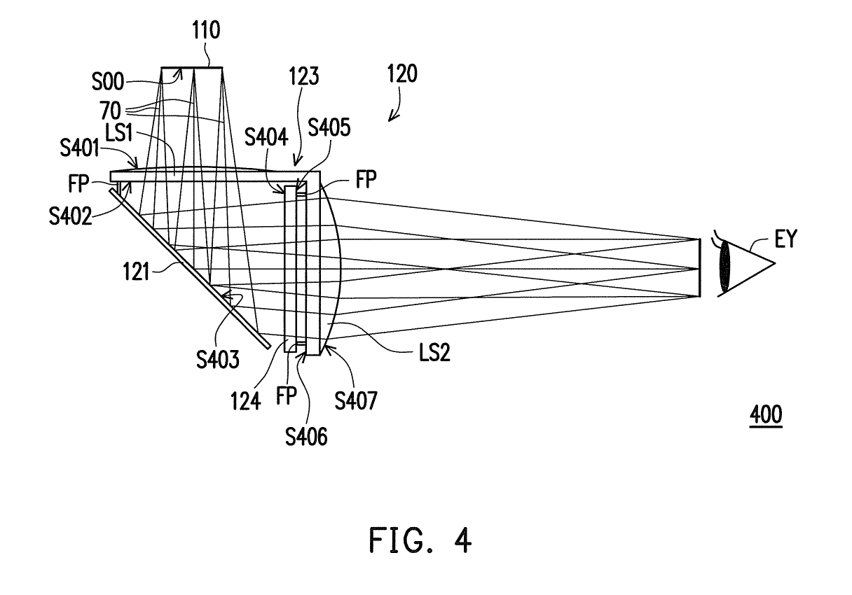

FIG. 4 is a schematic view of a virtual image display module according to still another embodiment of the present invention. With reference to FIG. 4, a virtual image display module 400 of the embodiment is similar to the virtual image display module 300 in FIG. 3, and the difference therebetween is described as below. In the virtual image display module 400 of the embodiment, the diffractive optical element 124 is disposed inside the L-type lens 123 and adjacent to the second lens portion LS2. In the embodiment, the operation of the virtual image display module 400 is similar to that of the virtual image display module 300. Thus, details related thereto can refer to the above description and will not be repeatedly described. Since the virtual image display module 400 and the virtual image display module 300 have similar structures, the issue that the positioning cannot be easily and precisely controlled during the assembly of a plurality of optical elements can be prevented by means of the integrally molded structure of the L-type lens 123, such that the difficulty of system assembling can be reduced. Therefore, the virtual image display module 400 have the same advantages as the virtual image display module 300, which will not be repeatedly described hereinafter.

An embodiment of the virtual image display module 400 is provided hereinafter. However, the invention is not limited to the data listed below. It should be known to those ordinary skilled in the art that various modifications and variations can be made to the structure of the present invention without departing from the scope or spirit of the invention.

TABLE 7

| | | Curvature | Interval | |
|---|---|---|---|---|
| Surface | Surface Type | Radius(mm) | (mm) | Note |
| S00 | Spheric | ∞ | 5.4 | Image display unit 110 |
| S401 | Aspheric | 17 | 1.0 | First lens portion LS1 |
| S402 | Spheric | ∞ | 6 | |
| S403 | Spheric | ∞ | 6 | Reflecting unit121 |
| S404 | Spheric | ∞ | 0.7 | Diffractive optical |
| | | | | element 124 |
| S405 | Spheric | ∞ | 0.5 | |
| S406 | Spheric | ∞ | 2.5 | Second lens portion LS2 |
| S407 | Aspheric | −12.8 | 25 | |

In Table 7, curvature radiuses and intervals have the same meanings as Table 1, which can refer to Table 1 and will not be repeatedly described below. Additionally, a surface S401 is a surface of the first lens portion LS1 facing toward the image display unit 110, a surface S402 is a surface of the first lens portion LS1 facing toward the reflecting unit 124, a surface S403 is a reflecting surface of the reflecting unit 121, surfaces S404 and S405 are two surfaces of the diffractive optical element 124, and surfaces S406 and S407 are two surfaces of the second lens portion LS2.

Based on the above, the surfaces S401 and S407 are aspheric, and the surface S404 is a diffraction surface, of which a formula thereof is the same as the formula applied in Table 1, where the physical meaning of each parameter can refer to the description with respect to Table 1 and will not be repeated below. Aspheric coefficients and each parameter value of the surfaces S401 and S407 and each parameter value of the surface S404 are listed in Table 8 and Table 9.

TABLE 8

| Surface | k | α₁ | α₂ | α₃ |
|---|---|---|---|---|
| S401 | 6 | 0 | −5.00E−04 | 0 |
| S407 | −1 | 0 | −2.00E−05 | 0 |

TABLE 9

| Surface | A2 | A4 | A6 |
|---|---|---|---|
| S404 | −800 | 140 | −40 |

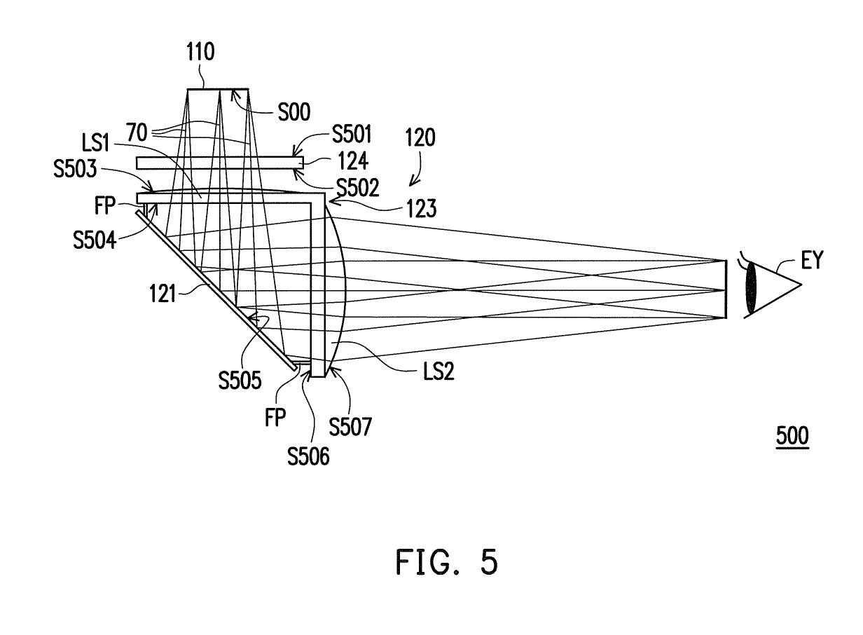

FIG. 5 is a schematic view of a virtual image display module according to another embodiment of the invention. With reference to FIG. 5, a virtual image display module 500 of the embodiment is similar to the virtual image display module 100 in FIG. 1, and the difference therebetween is described as below. In the virtual image display module 500 of the embodiment, the diffractive optical element 124 is disposed between the image display unit 110 and the first lens portion LS1. In the present embodiment, the operation of the virtual image display module 500 is similar to that of the virtual image display module 100. Thus, details related thereto can refer to the above description and will not repeatedly be described. Since the virtual image display module 500 and the virtual image display module 100 have similar structures, the virtual image display module 500 and the virtual image display module 100 both can achieve good imaging quality with the disposition of the diffractive optical element 124 as well as achieve light-weighted and small-volumed structures. Therefore, the virtual image display module 500 have the same advantages as the virtual image display module 100, which will not be repeatedly described hereinafter.

An embodiment of the virtual image display module 500 is provided hereinafter. However, the invention is not limited to the data listed below. It should be known to those ordinary skilled in the art that various modifications and variations can be made to the structure of the invention without departing from the scope or spirit of the invention.

TABLE 10

| | | Curvature | Interval | |
|---|---|---|---|---|
| Surface | Surface Type | Radius(mm) | (mm) | Note |
| S00 | Spheric | ∞ | 5.2 | Image display unit 110 |
| S501 | Spheric | ∞ | 0.7 | Diffractive optical |
| | | | | element 124 |
| S502 | Spheric | ∞ | 1.0 | |
| S503 | Aspheric | 31 | 1.0 | First lens portion LS1 |
| S504 | Spheric | ∞ | 6.2 | |
| S505 | Spheric | ∞ | 6.2 | Reflecting unit121 |
| S506 | Spheric | ∞ | 2.5 | Second lens portion LS2 |
| S507 | Aspheric | −11.8 | 25 | |

In Table 10, curvature radiuses and intervals have the same meanings as Table 1, which can refer to Table 1 and will not be repeatedly described below. Additionally, a surface S501 is a surface of the diffractive optical element 124 facing toward the image display unit 110, a surface S502 is a surface of the diffractive optical element 124 facing toward the first lens portion LS1, surfaces S503 and S504 are two surfaces of the first lens portion LS1, a surface S505 is a reflecting surface of the reflecting unit 121, and surfaces S506 and S507 are two surfaces of the second lens portion LS2.

Based on the above, the surfaces S503 and S507 are aspheric, and the surface S502 is a diffraction surface, of which a formula thereof is the same as the formula applied in Table 1, where the physical meaning of each parameter can refer to the description with respect to Table 1 and will not be repeated below. Aspheric coefficients and each parameter value of the surfaces S503 and S307 and each parameter value of the diffractive surface S502 are listed in Table 10 and Table 12.

TABLE 11

| Surface | k | α₁ | α₂ | α₃ |
|---|---|---|---|---|
| S503 | 25.5 | 0 | −4.30E−04 | 0 |
| S507 | −1.7 | 0 | −7.80E−05 | 0 |

TABLE 12

| Surface | A2 | A4 | A6 |
|---|---|---|---|
| S502 | −2700 | −350 | 820 |

To conclude, in the virtual image display module and the optical lens of the embodiments of the invention, the issue that the positioning cannot be easily and precisely controlled during the assembly of a plurality of optical elements can be prevented by means of the integrally molded structure of the L-type lens, such that difficulty of system assembling can be reduced to further lower down system manufacturing cost. Moreover, the virtual image display module and the optical lens can achieve good imaging quality with the disposition of the diffractive optical element as well as achieve light-weighted and small-volumed structures. On the other hand, the virtual image display module and the optical lens can contribute to adjusting the imaging position and the imaging frame size of the virtual image by means of adjusting the relative distance between the optical lens and the image display unit to improve the convenience in using the virtual image display module. Meanwhile, the user with myopia or hyperopia can clearly observe the frame displayed by the virtual image display apparatus without additionally wearing correction spectacles.

The embodiments described above are preferable embodiments of the invention. It is not intended to use the embodiments to limit the scope of the invention. Any simple and equivalent variation or modification based on the scope of claims and specification of the invention still falls within the scope of the invention. In addition, any of the embodiments or any of the claims of the invention does not need to achieve all of the objects, advantages or features disclosed by the invention. Moreover, the abstract and the headings are merely used to aid in searches of patent files and are not intended to limit the scope of the claims of the invention. In addition, terms such as “first” and “second” mentioned in the specification or the claims are only for naming the names of the elements or distinguishing different embodiments or scopes and are not intended to limit the upper limit or the lower limit of the number of the elements.

What is claimed is:

1. An optical lens, adapted for transmitting an image light beam generated by an image display unit to at least one eye of a user, comprising:
a reflecting unit, disposed on a transmission path of the image light beam;
an L-type lens, disposed on the transmission path of the image light beam and having a first lens portion and a second lens portion, the second lens portion is integrally molded with the first lens portion, wherein the first lens portion is disposed between the image display unit and the reflecting unit, and the second lens portion is disposed between the reflecting unit and the eye; and
a diffractive optical element, disposed on the transmission path of the image light beam, wherein the image light beam is transmitted to the eye through the first lens portion, the reflecting unit, the second lens portion and the diffractive optical element to provide a virtual image.

2. The optical lens according to claim 1, wherein the first lens portion has a first optical axis, the second lens portion has a second optical axis, a first included angle is between the first optical axis and the second optical axis, and the first included angle ranges about from 70 to 110 degrees.

3. The optical lens according to claim 1, wherein the L-type lens has at least one sidewall, and the at least one sidewall is connected with the first lens portion and the second lens portion.

4. The optical lens according to claim 1, wherein the L-type lens further has at least one positioning portion configured to install the reflecting unit.

5. The optical lens according to claim 4, wherein an amount of the at least one positioning portion is plural, and the positioning portions are configured to install the reflecting unit and the diffractive optical element.

6. The optical lens according to claim 1, wherein a second included angle is between the first lens portion and the second lens portion, and the second included angle ranges about from 70 to 110 degrees.

7. The optical lens according to claim 1, wherein the diffractive optical element is disposed inside the L-type lens and adjacent to the first lens portion.

8. The optical lens according to claim 1, wherein the diffractive optical element is disposed inside the L-type lens and adjacent to the second lens portion.

9. The optical lens according to claim 1, wherein the diffractive optical element is disposed between the second lens portion and the eye.

10. The optical lens according to claim 1, wherein the optical lens moves relatively to the image display unit to adjust an imaging position and an imaging frame size of the virtual image.

11. A virtual image display module, disposed in front of at least one eye of a user, comprising:
an image display unit, providing an image light beam; and
an optical lens, comprising:
a reflecting unit, disposed on a transmission path of the image light beam;
an L-type lens, disposed on the transmission path of the image light beam and having a first lens portion and a second lens portion, and the second lens portion is integrally molded with the first lens portion, wherein the first lens portion is disposed between the image display unit and the reflecting unit, and the second lens portion is disposed between the reflecting unit and the eye; and
a diffractive optical element, disposed on the transmission path of the image light beam, wherein the image light beam is transmitted to the eye through the first lens portion, the reflecting unit, the second lens portion and the diffractive optical element to provide a virtual image.

12. The virtual image display module according to claim 11, wherein the first lens portion has a first optical axis, the second lens portion has a second optical axis, a first included angle is between the first optical axis and the second optical axis, and the first included angle ranges about from 70 to 110 degrees.

13. The virtual image display module according to claim 11, wherein the L-type lens has at least one sidewall, and the at least one sidewall is connected with the first lens portion and the second lens portion.

14. The virtual image display module according to claim 11, wherein the L-type lens further has at least one positioning portion configured to install the reflecting unit.

15. The virtual image display module according to claim 14, wherein an amount of the at least one positioning portion is plural, and the positioning portions are configured to install the reflecting unit and the diffractive optical element.

16. The virtual image display module according to claim 11, wherein a second included angle is between the first lens portion and the second lens portion, and the second included angle ranges about from 70 to 110 degrees.

17. The virtual image display module according to claim 11, wherein the diffractive optical element is disposed between the image display unit and the first lens portion.

18. The virtual image display module according to claim 11, wherein the diffractive optical element is disposed inside the L-type lens and adjacent to the first lens portion.

19. The virtual image display module according to claim 11, wherein the diffractive optical element is disposed inside the L-type lens and adjacent to the second lens portion.

20. The virtual image display module according to claim 11, wherein the diffractive optical element is disposed between the second lens portion and the eye.

21. The virtual image display module according to claim 11, wherein the optical lens moves relatively to the image display unit to adjust an imaging position and an imaging frame size of the virtual image.
